(19) United States
(12) Patent Application Publication
(10) Pub. No.: US 2015/0017056 A1
(43) Pub. Date: Jan. 15, 2015

(54) SOFT MAGNETIC METAL POWDER, METHOD FOR PREPARING THE SAME, AND ELECTRONIC COMPONENTS INCLUDING THE SAME AS CORE MATERIAL

(71) Applicant: SAMSUNG ELECTRO-MECHANICS CO., LTD., Suwon-si (KR)

(72) Inventors: Hak Kwan KIM, Suwon-si (KR); Sang Kyun KWON, Suwon-si (KR); Sung Jae LEE, Suwon-si (KR); Sung Yong AN, Suwon-si (KR)

(21) Appl. No.: 14/328,351

(22) Filed: Jul. 10, 2014

(30) Foreign Application Priority Data
Jul. 11, 2013 (KR) 10-2013-0081646

(51) Int. Cl. H01F 1/147; H01F 1/20; B22F 1/02; C23C 8/66; C21D 9/00

(52) U.S. Cl. CPC H01F 1/147; C23C 8/66; C21D 9/0068; B22F 1/02; H01F 1/20
USPC 420/8; 427/127; 148/104; 148/306

(57) ABSTRACT

Disclosed herein are a soft magnetic metal powder having a pearlite lamellar structure in which ferrite structures and cementite structures are repeated, a method for preparing the same, and an electronic component including the same as a core material.

According to the present invention, the soft magnetic metal powder having the pearlite lamellar structure in which the ferrite structures and the cementite structures are repeated may be easily prepared, and an eddy current loss may be easily decreased without changing the existing molding process, such that the soft magnetic metal powder may be used as a core material of various electronic components such as an inductor, a motor, an actuator, a sensor, a transformer, and a reactor, requiring soft magnetic properties.

### CROSS REFERENCE(S) TO RELATED APPLICATIONS

This application claims the benefit under 35 U.S.C. Section 119 of Korean Patent Application Serial No. 10-2013-0081646, entitled “Soft Magnetic Metal Powder, Method for Preparing the Same, and Electronic Components Including the Same as Core Material” filed on Jul. 11, 2013, which is hereby incorporated by reference in its entirety into this application.

### BACKGROUND OF THE INVENTION

1. Technical Field

The present invention relates to a soft magnetic metal powder, a method for preparing the same, and electronic components including the same as a core material.

2. Description of the Related Art

In general, a soft magnetic material has been used in various fields such as a core in an inductor, a stator and a rotator of an electric device such as a motor, an actuator, a sensor, and a core in a transformer.

The soft magnetic core such as the rotator and the stator of the electric device is generally prepared by stacking a number of fabricated steel plates and fixing them so as to be integrated. However, in the case in which the steel plates are stacked, it has difficulties in preparing a product having three dimensional complicated shapes, and problems in that a large loss in a scrap metal thereof is generated.

Therefore, recently, an improved core which is easily prepared and has a high degree of freedom in view of a shape thereof is prepared by high pressure molding the soft magnetic powder.

The soft magnetic powder to be used in this case, which is a powder having magnetism when electricity is applied thereto, is generally based on Fe-based soft magnetic particles, and the soft magnetic powder is used to prepare the soft magnetic core through a general powder metallurgical process. That is, after the powder is prepared in a powder form through a spraying method, a grinding method, or the like, a mechanical process or a heat treatment, or the like, is performed on the corresponding powder, such that the soft magnetic powder capable of being appropriately used as a core material may be prepared.

The soft magnetic powder has various shapes such as a round shape, a flat shape, a multiple shape, and the like, has a size which allows good molding density and magnetic flux density, and it is preferred that the soft magnetic powder has a uniform particle size through a sorting process.

An insulating coating is performed by mixing ceramic coating or epoxy coating the prepared soft magnetic powder. Here, the mixing ceramic to be added for the insulating coating is based on oxides having large resistance such as phosphate, silica (SiO₂), and sodium silicate, and the ceramic coating allows each powder to be electrically separated from each other, such that a loss in an eddy current of the core material is decreased. The insulating coating is performed as described above, such that the soft magnetic powder consists of a general soft magnetic composite (SMC).

Here, it has been tried that in order to decrease an inter-particle eddy current loss, in all soft magnetic powder, an insulating coating is performed thereon, a size of particle thereof is decreased, a composite of a material itself is changed, or a constitution such as an amorphous or nanocrystalline powder is changed.

However, in order to prepare the amorphous or nanocrystalline powder, it has difficulties in rapidly solidifying, designing an atomizer, and the like, and has limitations in particle size control and heat treatment temperature.

Meanwhile, a Fe-based powder has been generally used in high Ms, as a frequency is higher, a size of the eddy current generated in α-Fe is rapidly increased, such that the Fe-based powder is not usable due to the eddy current loss.

Therefore, in order to decrease the inter-particle eddy current loss generated in a metal powder itself, the amorphous powder having large specific resistance and the nanocrystalline powder have been developed, however, the amorphous powder and the nanocrystalline powder have problems in that a phase thereof is transformed by heat-treatment, and difficulties in that it is difficult to be prepared.

### RELATED ART DOCUMENT

### Patent Document

(Patent Document 1) Japanese Patent Laid-Open Publication No. 2009-249739

### SUMMARY OF THE INVENTION

An object of the present invention is to provide a soft magnetic metal powder having a structure in which an inter-particle eddy current loss generated in the soft magnetic metal powder itself is minimized.

In addition, another object of the present invention is to provide a method for preparing the soft magnetic metal powder.

Further, another object of the present invention is to provide various electronic products including the soft magnetic metal powder as a core material.

According to a first exemplary embodiment of the present invention, there is provided a soft magnetic metal powder having a pearlite lamellar structure in which ferrite structures and cementite structures are repeated.

The ferrite structure may be made of α-Fe.

The cementite structure may be made of Fe₃C.

A particle size of the soft magnetic metal powder may be 1 to 100 μm.

The ferrite structure and the cementite structure may be controlled by a carbon content.

The carbon content may be 0.8 to 1 wt % based on a content of an α-Fe powder forming the ferrite structure.

The soft magnetic metal powder may be used at a high frequency of 0.1 to 30 MHz.

According to a secondary exemplary embodiment of the present invention, there is provided a method for preparing a soft magnetic metal powder having a pearlite lamellar structure in which ferrite structures and cementite structures are repeated, the method including: infiltrating carbon into an α-Fe powder; and heat-treating the α-Fe powder having the carbon infiltrated thereinto.

The carbon may be infiltrated in a content of 0.8 to 1 wt % based on a content of the α-Fe powder.

The heat-treating may be performed at 740 to 800° C.

The ferrite structure may be made of α-Fe.

The cementite structure may be made of Fe₃C formed by combining the α-Fe powder and the carbon with each other.

According to a third exemplary embodiment of the present invention, there is provided an electronic component including the soft magnetic metal powder as described above as a core material.

The electronic component may be any one selected from an inductor, a motor, an actuator, a sensor, a transformer, and a reactor.

### BRIEF DESCRIPTION OF THE DRAWINGS

FIG. 1 shows a pearlite lamellar structure in which ferrite structures and cementite structures are repeated of a soft magnetic metal powder according to an exemplary embodiment of the present invention;

FIG. 2 is a photograph obtained by observing the pearlite lamellar structure of the soft magnetic metal powder prepared by the exemplary embodiment of the present invention using scanning electron microscope (SEM); and

FIG. 3 shows results obtained by measuring an eddy current loss depending on a frequency of powder inductors manufactured by Example 2 and Control Group 1 of the present invention.

### DESCRIPTION OF THE PREFERRED EMBODIMENTS

Hereinafter, the present invention will be described in more detail.

Terms used in the present specification are used for explaining specific embodiments rather than limiting the present invention. Unless explicitly described to the contrary, a singular form may include a plural form in the present specification. The word “comprise” and variations such as “comprises” or “comprising,” will be understood to imply the inclusion of stated constituents, numbers, steps, operations, members, and/or elements but not the exclusion of any other constituents, numbers, steps, operations, member, and/or elements.

The present invention provides a soft magnetic metal powder, a method for preparing the same, and various electronic components including the same as a core material.

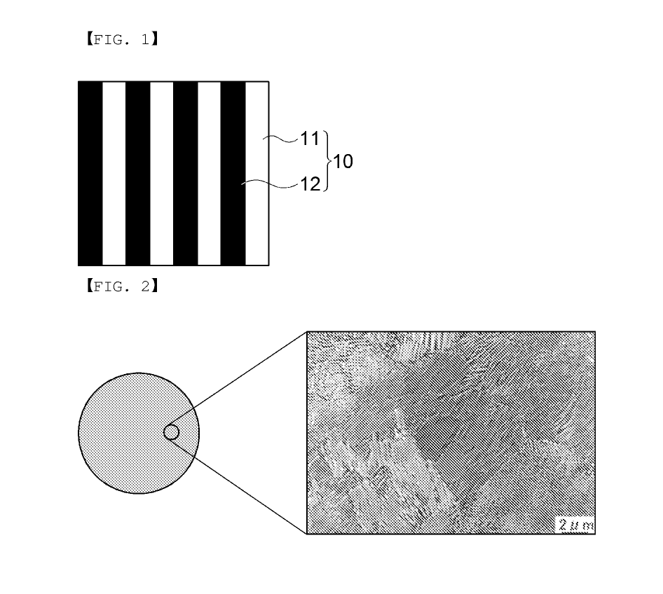

In particular, the soft magnetic metal powder according to an exemplary embodiment of the present invention may have a pearlite lamellar structure 10 in which ferrite structures 11 and cementite structures 12 are repeated as shown in FIG. 1.

The “pearlite lamellar structure” of the soft magnetic metal powder according to the exemplary embodiment of the present invention refers to a structure in which the ferrite structures and the cementite structures are combined with each other in layers, wherein the soft magnetic metal powder according to the exemplary embodiment of the present invention may be formed by combining the plurality of pearlite lamellar structures.

In the soft magnetic metal powder of the present invention, the “ferrite structure” may be made of α-Fe. That is, the ferrite structure is formed by α-Fe consisting of the soft magnetic metal powder.

The α-Fe is a pure iron phase in which impurities such as carbon and the like have a content of 0.02% or less, wherein at a temperature of 912° C., the phase thereof is transformed from body-centered cubic (BCC) to face-centered cubic (FCC) to be in a structure of austenite. Since a solid solubility of carbon is increased up to 2% in the austenite phase, the solid solubility of carbon may be increased by 100 times or more. However, the above case occurs in a high temperature phase, and when the temperature is room temperature, the solid solubility of carbon is decreased, such that cementite, that is, Fe₃C is extracted.

In addition, in the soft magnetic metal powder of the present invention, the “cementite structure” may be made of Fe₃C. That is, α-Fe consisting of the soft magnetic metal powder and the infiltrated carbon (C) are combined to form Fe₃C in the cementite structure.

The carbon (C) is diffusedly infiltrated into the α-Fe powder, and the infiltrated carbon content may control the ferrite structure and the cementite structure in the soft magnetic metal powder.

In order to have an ideal pearlite lamellar structure according to the exemplary embodiment of the present invention, the carbon content may be controlled to be 0.8 to 1 wt % based on a content of the α-Fe powder. In the case in which the infiltrated carbon content is less than 0.8 wt % based on the content of the α-Fe powder, an interval between the cementite layers forming the lamellar structure is large and there is a region in which the structure is not formed, such that it is not preferred in view of decreasing the eddy current loss. In addition, in the case in which the infiltrated carbon content is more than 1 wt %, the cementite region is rapidly increased, such that a magnetic flux density is decreased by the ferrite, which is not preferred in that the entire inductance is deteriorated.

When considering the permeability and the core loss at the same time, it is preferred that the soft magnetic metal powder having the pearlite lamellar structure in which the ferrite structures and the cementite structures are repeated according to the exemplary embodiment of the present invention has a particle size of 1-100 μm, in view of efficiency of an inductor and a motor.

In the soft magnetic metal powder having the above-described structure according to the exemplary embodiment of the present invention, the cementite structure functions as an insulating layer with respect to the ferrite structure only made of the α-Fe powder, such that the eddy current loss may be significantly decreased.

Therefore, since the soft magnetic metal powder according to the exemplary embodiment of the present invention decreases the entire eddy current loss as compared to the soft magnetic metal powder according to the related art, the powder may be used in the high frequency of 0.1 to 30 MHz.

Hereinafter, a method for preparing a soft magnetic metal powder according to the exemplary embodiment of the present invention will be described.

The soft magnetic metal powder according to the exemplary embodiment of the present invention may be prepared by infiltrating carbon into an α-Fe powder, and heat-treating the α-Fe powder having the carbon infiltrated thereinto to have a pearlite lamellar structure in which ferrite structures and cementite structures are repeated.

First, the carbon is infiltrated into the α-Fe powder which is a raw material of the soft magnetic metal powder. Examples of methods for infiltrating the carbon may include a solid-state carburization, a gas carburization, and a low temperature plasma carburization, but the present invention is not specifically limited thereto.

According to the present invention, since the ferrite structure and the cementite structure are controlled by the infiltrated carbon content, the infiltrated carbon content is important. In the present invention, the carbon may be infiltrated in a content of 0.8 to 1 wt % based on the content of the α-Fe powder, which significantly prevents the eddy current loss and simultaneously satisfies the magnetic flux density.

Then, the α-Fe powder having the carbon infiltrated thereinto is heat-treated. The heat-treatment may be performed at 740-800° C. for 2 to 3 hours, which is preferred in that the carbon may be sufficiently solidified in a state in which the austenite phase is phase-transformed.

In addition, the heat-treatment is preferably performed under an inert gas such as argon (Ar) atmosphere.

Further, the heat-treated α-Fe powder may be cooled in a furnace.

The pearlite lamellar structure 10 in which the ferrite structures 11 and the cementite structures 12 are repeated is formed by the heat-treatment as shown in FIG. 1, such that the size of the eddy current generated in the high frequency may be significantly small.

The ferrite structure may be made of α-Fe, and the cementite structure may be made of Fe₃C formed by combining the α-Fe and the carbon with each other.

In the method for preparing the soft magnetic metal powder according to the present invention, the existing complicated processes such as manufacture of the amorphous or the nanocrystalline powder are not required, and the pearlite lamellar structure may be easily formed only by the carburization treatment and the heat treatment with simple control in the carbon content.

Therefore, only the heat treatment is performed on the existing α-Fe powder, such that a magnetic device which is capable of being applied in the high frequency may be manufactured, and the eddy current loss may be easily decreased without changing the existing molding process.

The present invention may provide electronic components including the soft magnetic metal powder having the pearlite lamellar structure in which the ferrite structures and the cementite structures are repeated as the core material.

The electronic component may be any one selected from an inductor, a motor, an actuator, a sensor, a transformer, and a reactor, but the present invention is not limited thereto.

Hereinafter, preferred examples of the present invention will be described in detail. The examples below are described by way of example, and therefore, the scope of the present specification and claims should not be interpreted as being limited to the example. In addition, the examples below are exemplified using specific compounds, but it is obvious to those skilled in the art that an effect obtained by using equivalents thereof can be the same as or similar to that of the present invention.

### Example 1

A carbon in a content of 0.8 wt % based on a content of the α-Fe powder was infiltrated into an α-Fe powder (impurities content of 0.02% or less) having a particle size of 20 μm by using a gas carburization method.

The α-Fe powder having the carbon infiltrated thereinto was heat-treated under an argon (Ar) inert gas at 760° C. for 2 hours, and cooled at a furnace, thereby finally obtaining a soft magnetic metal powder.

### Experimental Example 1

### Confirmation of Structure

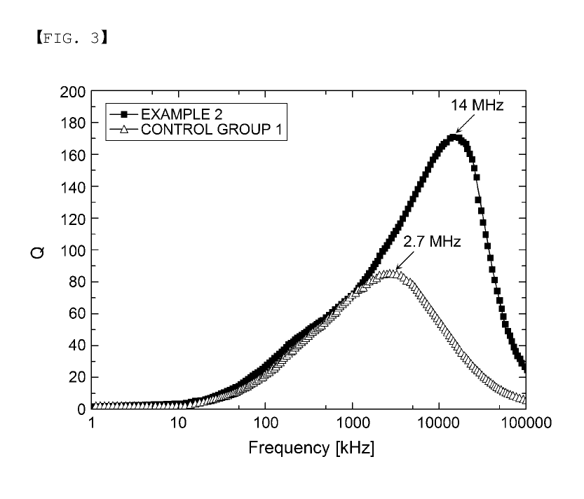

A structure of the soft magnetic metal powder prepared by Example 1 of the present invention was confirmed by using a scanning electron microscope (SEM), and the result thereof was shown in FIG. 2.

It was confirmed from FIG. 2 that the soft magnetic metal powder according to the exemplary embodiment of the present invention had a pearlite lamellar structure in which ferrite structures (black) and cementite structures (white) are repeated.

### Example 2

### Manufacture of Power Inductor

A power inductor was manufactured by using the soft magnetic metal powder prepared by Example 1 of the present invention as a core material. The power inductor was manufactured by the general method.

Control Group 1

A power inductor as a control group was manufactured by the same method as Example 2 of the present invention except for using an untreated α-Fe powder as a core material.

### Experimental Example 2

### Measurement of Eddy Current Loss

An eddy current loss of the power inductors manufactured by Example 2 and Control Group 1 was measured by using an impedance analyzer while frequency is changed from 1 kHz to 100 MHz, and the result thereof was shown in FIG. 3.

In the present experiment, Q values (Q=rear permeability/imaginary permeability of the material) depending on the change in frequency indicates the eddy current loss of the material. That is, it may be determined that the larger the Q value, the smaller the eddy current loss of the material and the higher the efficiency, and the larger the frequency value at which the maximum value of the Q value appears, the better the high frequency properties.

It may be appreciated from FIG. 3 that in Example having the lamellar structure, the Q value thereof is two times larger than in the Control Group 1, and the frequency value at which the maximum value of the Q value capable of controlling the real high frequency properties appears is 14 MHz, which is better than 2.7 MHz in the Control Group 1.

According to the exemplary embodiment of the present invention, only the heat treatment process is performed on the existing α-Fe powder, such that the soft magnetic metal powder capable of being applied to the high frequency may be prepared.

In addition, the soft magnetic metal powder according to the exemplary embodiment of the present invention may have a pearlite lamellar structure in which ferrite structures and cementite structures are repeated, whereby the eddy current loss may be easily decreased without changing the existing molding process.

Therefore, the soft magnetic metal powder according to the exemplary embodiment of the present invention may be used as the core material of various electronic components such as the inductor, the motor, the actuator, the sensor, the transformer, and the reactor, requiring the soft magnetic properties, whereby the eddy current loss may be remarkably decreased even in the high frequency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A soft magnetic metal powder having a pearlite lamellar structure in which ferrite structures and cementite structures are repeated.

2. The soft magnetic metal powder according to claim 1, wherein the ferrite structure is made of α-Fe.

3. The soft magnetic metal powder according to claim 1, wherein the cementite structure is made of Fe₃C.

4. The soft magnetic metal powder according to claim 1, wherein a particle size of the soft magnetic metal powder is 1 to 100 μm.

5. The soft magnetic metal powder according to claim 1, wherein the ferrite structure and the cementite structure are controlled by a carbon content.

6. The soft magnetic metal powder according to claim 5, wherein the carbon content is 2 wt % or less based on a content of an α-Fe powder forming the ferrite structure.

7. The soft magnetic metal powder according to claim 1, wherein it is usable at a high frequency of 0.1 to 30 MHz.

8. A method for preparing a soft magnetic metal powder having a pearlite lamellar structure in which ferrite structures and cementite structures are repeated, the method comprising:
infiltrating carbon into an α-Fe powder; and
heat-treating the α-Fe powder having the carbon infiltrated thereinto.

9. The method according to claim 8, wherein the carbon is infiltrated in a content of 2 wt % or less based on a content of the α-Fe powder.

10. The method according to claim 8, wherein the heat-treating is performed at 740 to 800.

11. The method according to claim 8, wherein the ferrite structure is made of α-Fe.

12. The method according to claim 8, wherein the cementite structure is made of Fe₃C formed by combining the α-Fe powder and the carbon with each other.

13. An electronic component comprising the soft magnetic metal powder according to claim 1 as a core material.

14. The electronic component according to claim 13, wherein it is any one selected from an inductor, a motor, an actuator, a sensor, a transformer, and a reactor.
